(19) United States
(12) Patent Application Publication
(10) Pub. No.: US 2009/0085886 A1
(43) Pub. Date: Apr. 2, 2009

(54) Method and apparatus for performing view switching functions on handheld electronic device with touch screen

(75) Inventors: Cheng-Wen Huang, (US); Chun-Chi Chen, (US)

Correspondence Address: BIRCH STEWART KOLASCH & BIRCH, PO BOX 747, FALLS CHURCH, VA, 22040-0747, US

(73) Assignees: GIGA-BYTE TECHNOLOGY CO., LTD. &; GIGA-BYTE COMMUNICATIONS, INC.

(21) Appl. No.: 12/155,210

(22) Filed: May 30, 2008

(30) Foreign Application Priority Data
Oct. 1, 2007 (TW) 096136789

(51) Int. Cl. G06F 3/041

(52) U.S. Cl. 345/173

(57) ABSTRACT

A method for performing a view switching function of a handheld device with a touch screen is provided. The handheld device has an LCD panel and a touch panel. The touch panel has a touch region larger than a display area of the LCD panel. The touch panel has a main touch region overlapping the LCD panel, and an assistant touch region surrounding but not overlapping the LCD panel. The method includes (a) when the touch panel detects a presence of an object, determining whether the main touch region or the assistant touch region is touched; (b) when it is determined that the main touch region is touched, and it is determined that the object slides to the assistant touch region, switching from a first view to a second view displayed on the LCD panel; and (c) when it is determined that the assistant touch region is touched, and it is determined that the object slides to the main touch region, switching from a third view to a fourth view displayed on the LCD panel.

### CROSS-REFERENCE TO RELATED APPLICATIONS

This nonprovisional application claims priority under 35 U.S.C. §119(a) on Patent Application No. 096136789, filed in Taiwan on Oct. 1, 2007, the entirety of which is incorporated herein by reference.

### BACKGROUND OF THE INVENTION

1. Field of the Invention:

The present invention relates to a touch screen, and more particularly, to a method and an apparatus for switching functions of a handheld electronic device with a touch screen.

2. Background of the Invention:

A handheld device comprises a user-interface, which has numbers, letters, phonetic notations, etymons, or other icons thereon, for inputting data and operating the device. Generally, the user-interface may include a keypad having a plurality of buttons or keys, or a touch sensitive screen.

In prior art, most of the inputting interfaces of the handheld devices are designed to have a plurality of buttons or keys. To get a bigger screen, some of the buttons or keys are omitted. Instead, a touch panel is attached to the liquid crystal screen or to the other buttons or keys, so that the users could input data more conveniently.

However, the user may need to press buttons or touch the touch screen several times before he can open a certain folder or perform a certain function, which causes inconvenience, especially when the user is driving a car.

Therefore, there is a need to provide a quick way to switch to a new function of the handheld electronic device.

### SUMMARY OF THE INVENTION

It is one object of the present invention to provide an apparatus with a touch panel and an LCD panel, and the touch panel is larger in area than the LCD panel. Of the touch panel, the region which overlaps the LCD panel is set up as the main touch region, and the excessive region around the main region is set up as the assistant touch region.

It is another object of the present invention to provide a method to operate the apparatus as mentioned above. The gesture of sliding from the main region to the assistant region or the gesture of sliding from the assistant region can cause the switch of views accordingly, without affecting the original operations of the main touch region.

When a user operates the handheld device, he may touch the touch screen with an object such as a finger, and the touch panel will detect the presence of the finger. The location of the finger will be monitored and it is determined whether the main touch region or the assistant touch region is touched.

If the main touch region is touched and the finger slides from the main touch region to the assistant touch region, the view corresponding to this gesture will be displayed. If the finger slides from the assistant touch region back to the main touch region, the previous view will be displayed.

If the main touch region is touched and the finger does not slide from the main touch region to the assistant touch region, the corresponding function of the main touch panel will be performed.

If the finger touches the assistant touch region and then slides to the main touch region, the view corresponding to this gesture will be displayed. If the finger slides back from the main touch region to the assistant touch region, the previous view will be displayed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A illustrates a handheld electronic device according to an embodiment of the present invention;

FIG. 1B and FIG. 1C illustrate switching between different views of the user interface;

FIG. 2 is a flowchart of the function switching method for the handheld electronic device according to an embodiment of the present invention;

FIG. 3 illustrates an embodiment of sliding the finger on the touch screen;

FIG. 4 illustrates another embodiment of sliding the finger on the touch screen;

FIG. 5 illustrates an embodiment of predefining the coordinate of the touch point on the touch screen;

FIG. 6 illustrates an embodiment of determining the coordinate of the touch point; and

FIG. 7 illustrates an embodiment of the sliding path of the finger from the jumping-off point to the terminal point.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

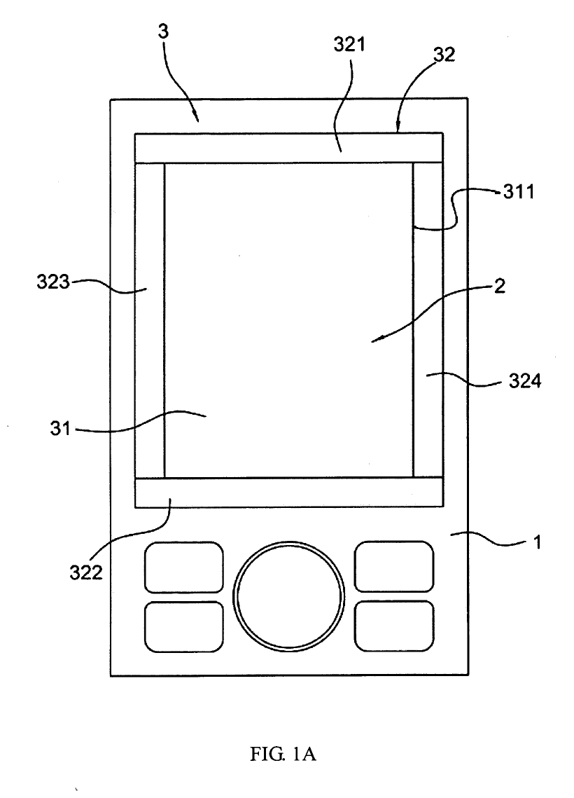

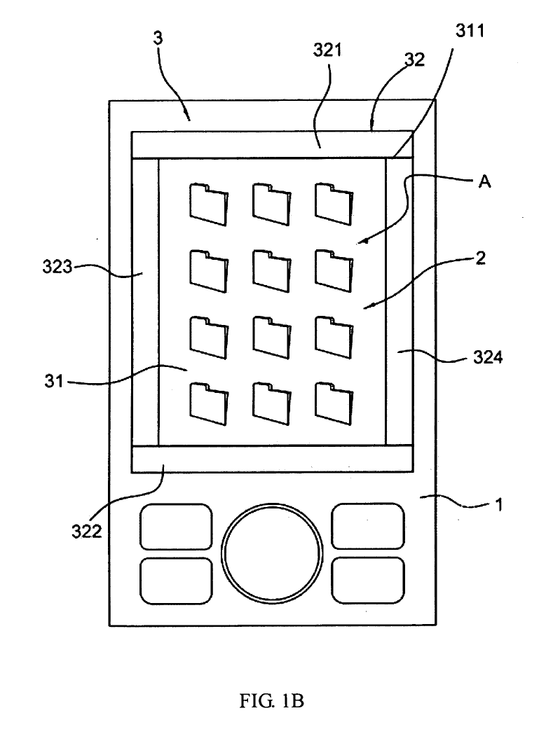

Referring to FIG. 1A, a handheld electronic device comprises an LCD panel 2 and a touch panel 3. The touch panel 3 has a touch region larger the display area of the LCD panel 2. The central region of the touch panel 3, which has the same size as the display area of the LCD panel 2, is defined as the main touch region 31, and the boundary of the main touch region 31 is defined as the borderline 311.

The surrounding region that surrounds the LCD panel 2 is defined as the assistant touch region 32, and the assistant touch region 32 is divided into a first touch region (top) 321, a second touch region (bottom) 322, a third touch region (left) 323, and a fourth touch region (right) 324. When a finger of a user touches any of the four touch regions 321-324, and slides across the borderline 311 to the main touch region 31, or vice versa, the screen of the electronic device will switch to a different view.

For example, as shown in FIG. 1B, the LCD panel 2 of the handheld electronic device is displaying view A. If the finger of the user slides from the main touch region 31 to the second touch region 322 of the assistant touch region 32, the internal system of the electronic device will switch the view from view A to view B (shown in FIG. 1C). If the finger of the user slides from the second touch region 322 back to the main touch region 31, the view shown in the display will switch from view B to view A. In this embodiment, the views can be different directories, web pages or pictures.

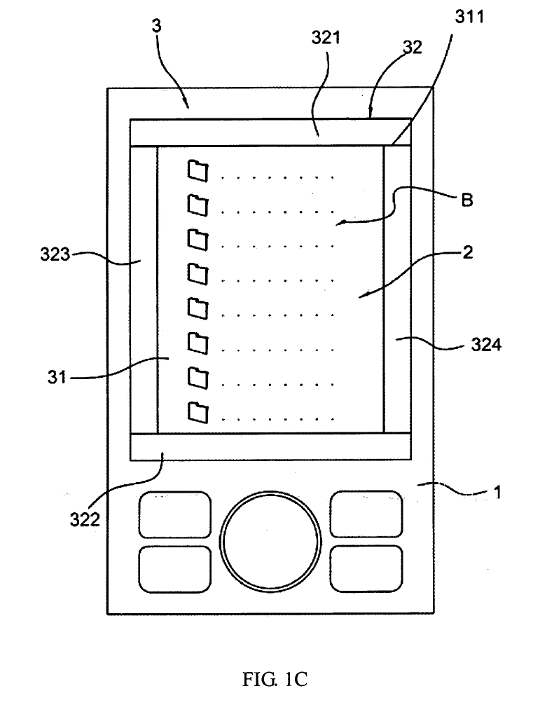

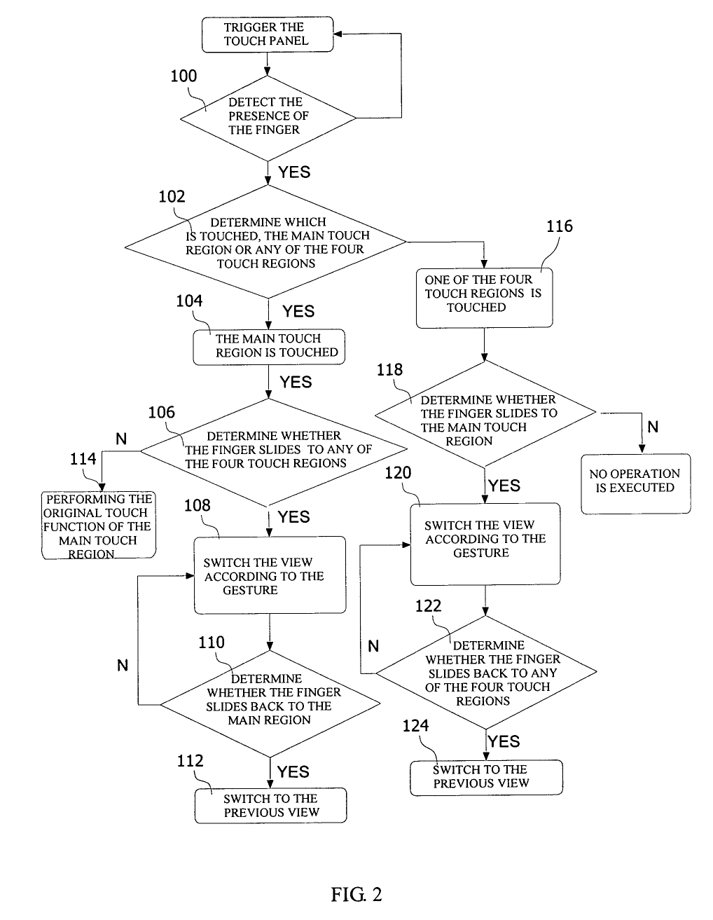

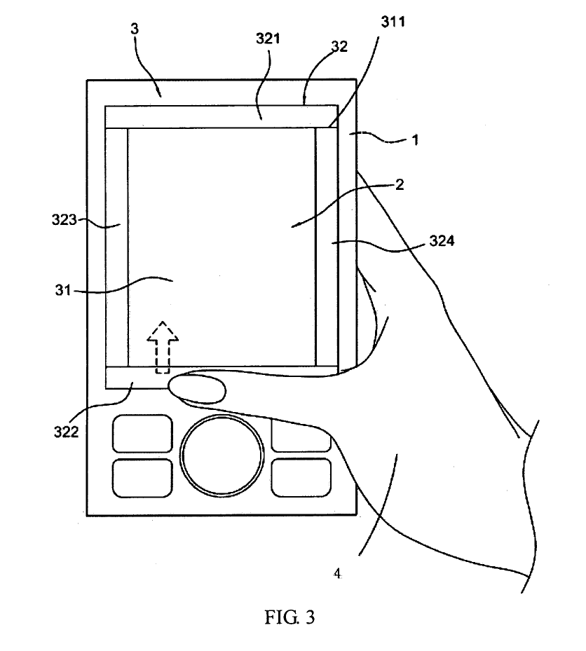

Referring to FIGS. 2-4, a user is operating the handheld device with a finger. First, in step 100, the system detects whether the touch panel 3 is touched by the finger 4. If so, the location of the finger will be monitored and it will be determined which touch region is touched in step 102. If it is determined that the main touch region 31 is touched (as shown in step 104), then it will be determined in step 106 whether the finger slides from the main touch region 31 to any of the four touch regions 321-324 of the assistant touch region 32. If the answer is yes, a corresponding view switch will be performed (as shown in step 108). Then the system determines whether the finger slides from any of the four touch regions 321-324 to the main touch region 31 (as shown in step 110). If not, the system proceeds back to step 108; if the answer is yes, the previous view will be displayed in step 112. If it is determined in step 106 that the finger does not slide from the main touch region 31 to any of the four touch regions 321-324 of the assistant touch region 32, the original function of the main touch region 31 will be performed.

If it is determined in step 102 that any of the four touch regions 321-324 of the assistant touch region is touched (as shown in step 116), then the system proceeds to step 118 and determines whether the finger slides to the main touch region 31. If the answer is yes, the operation of view switch will be performed (as shown in step 120). Then the system proceeds to step 122 and determines whether the finger slides from the main touch region 31 back to any of the four touch regions 321-324 of the assistant touch region 32. If the answer is yes, the previous view will be displayed (as shown in step 124).

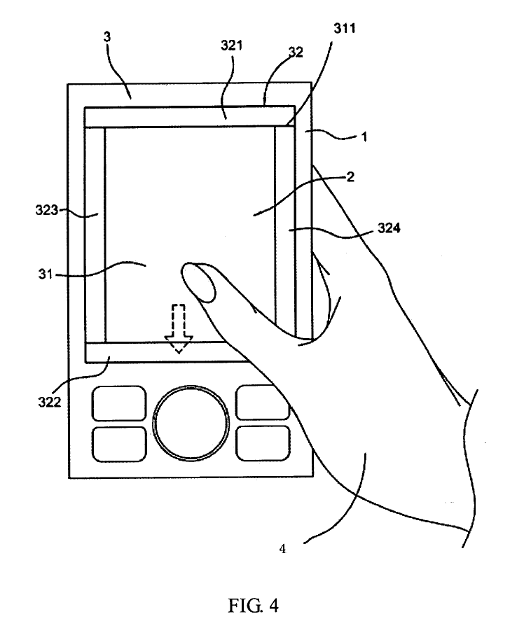

FIG. 5 illustrates an example of a 240*320 LCD panel 2 and a 280*360 touch panel 3 to provide a detailed description of the invention. The touch panel 3 is fixed on the LCD panel 2, and the four regions not overlapped by the LCD panel 2 are the first touch region (top) 321, the second touch region (bottom) 322, the third touch region (left) 323, and the fourth touch region (right) 324. There is a twenty-pixel gap between the boundary of the LCD panel and the boundary of each of the four touch regions.

The coordinates of the four corners of the assistant touch panel 32 are defined as, top left corner (−20, −20), top right corner (260, −20), bottom left corner (−20, 340), and bottom right corner (260, 340). The coordinates of the four corners of the main touch area 31 are defined as, top left corner (0, 0), top right corner (240, 0), bottom left corner (0, 320), and bottom right corner (240, 320).

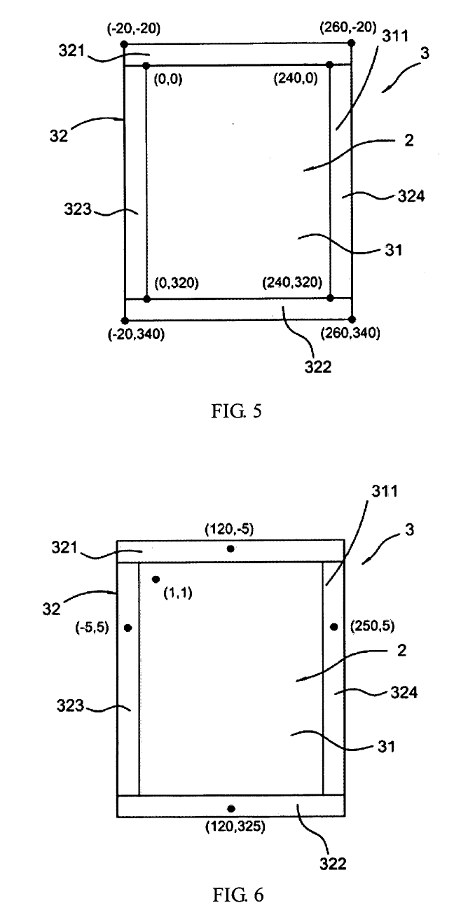

Referring to FIG. 6, the system determines which touch region is touched and reads the coordinate (X, Y) of the touch point 30 from the touch panel 3.

When 0□X□240 and 0□Y□320, the coordinate is in the main touch region 31. For example, the coordinate (1,1) is in the main touch region 31, because

X=1, and 0<1<240; and

Y=1, and 0<1<320.

When X<0 and 0□Y□320, the coordinate is in the third touch region 323 of the assistant touch region 32. For example, the coordinate (−5, 5) is in the third touch region 323, because

X=−5<0; and

Y=5, and 0<5<320.

When X>240 and 0<Y<320, the coordinate is in the fourth touch region 324 of the assistant touch region 32. For example, the coordinate (250, 5) is in the fourth touch region 324, because

X=250>240; and

Y=5, and 0<5<320.

When Y<0, the coordinate is in the first touch region 321 of the assistant touch region 32. For example, the coordinate (120, −5) is in the first touch region 321, because

Y=−5<0

When Y>320, the coordinate is in the second touch region 322 of the assistant touch region 32. For example, the coordinate (120, 325) is in the second touch region 321, because

Y=325>320

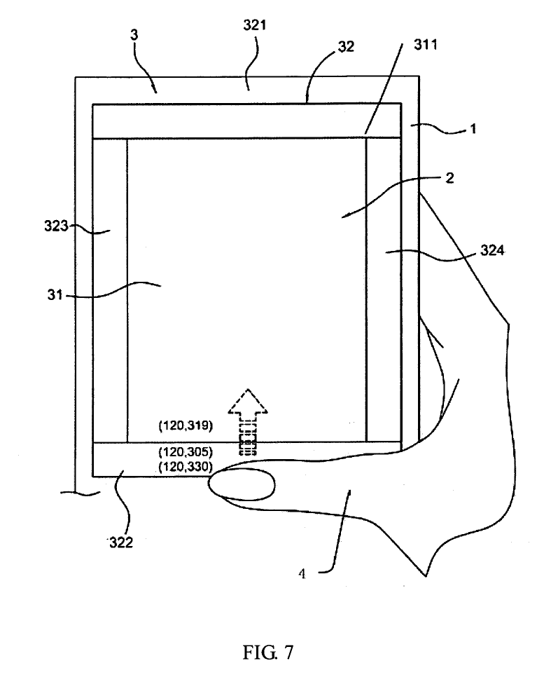

Referring to FIG. 7, when the user touches the second touch region 322 with a finger 4, the coordinate of the start point is (120, 330). The system therefore will figure out that the start point is in the second touch region 322, and a record is generated and recorded accordingly.

When the finger 4 slides upwards to the point (120, 325), no event will be triggered because the coordinate (120, 325) is still in the second touch region 322.

When the finger 4 moves on upwards to the point (120, 319), according to the coordinate (120, 330) as the start point and the coordinate (120, 319) as the end point, the system will figure out that the finger 4 has slid to the main touch region 31, and therefore will perform the corresponding view switch.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for performing a view switching function on a handheld device with a touch screen, the handheld device having an LCD panel and a touch panel, the touch panel having a touch region larger than a display area of the LCD panel, the touch panel having a main touch region overlapping the LCD panel, and an assistant touch region surrounding but not overlapping the LCD panel, the method comprising:
(a) when the touch panel detects a presence of an object, determining whether the main touch region or the assistant touch region is touched;
(b) when it is determined that the main touch region is touched, and it is determined that the object slides to the assistant touch region, switching from a first view to a second view displayed on the LCD panel; and
(c) when it is determined that the assistant touch region is touched, and it is determined that the object slides to the main touch region, switching from a third view to a fourth view displayed on the LCD panel.

2. The method of claim 1, wherein after step (b), when it is determined the objects slides from the assistant touch region back to the main touch region, switching back to the first view.

3. The method of claim 1, wherein after step (c), if it is determined the objects slides from the main touch region back to the assistant touch region, switching back to the third view.

4. The method of claim 1, wherein in step (b), if it is determined that the object slides inside the main touch region, performing an original function of the main touch region.

5. The method of claim 1, wherein the assistant touch region includes a first touch region, a second touch region, a third touch region and a fourth touch region.

6. The method of claim 5, wherein the first touch region, the second touch region, the third touch region, and the fourth touch region are respectively on four sides of the main touch region.

7. The method of claim 6, further comprising defining a coordinate coverage corresponding to the main touch region, the first touch region, the second touch region, the third touch region and the fourth touch region.

8. The method of claim 7, wherein the touch panel determines whether the object is sliding according to a continuity of the coordinate of the object.

9. The method of claim 8, wherein the touch panel determines a start point and an end point of the object according to the coordinate coverage.

10. An apparatus for switching functions on a touch screen of a handheld electronic device, comprising:
an LCD panel; and
a touch panel having a touch region larger than a display area of the LCD panel, the touch region including a main touch region overlapping the LCD panel, and an assistant touch region surrounding but not overlapping the LCD panel;
wherein a view switching function is performed when it is determined that an object touching the touch panel slides across a boundary between the main touch region and the assistant touch region.

11. The apparatus of claim 10, wherein the view switching function is performed to switch from a first view to a second view displayed on the LCD panel.

12. The apparatus of claim 10, wherein the main touch region and the assistant touch region are integrally formed as a unitary device.

13. The apparatus of claim 10, wherein the assistant touch region includes a first touch region, a second touch region, a third touch region and a fourth touch region.
